(19) United States
(12) Patent Application Publication
(10) Pub. No.: US 2025/0222590 A1
(43) Pub. Date: Jul. 10, 2025

(54) AUTONOMOUS ROBOTIC PICK AND PLACE SYSTEM AND METHOD

(71) Applicant: ALTITUDE ROBOTS, INC. DBA ALTITUDE AI, Salt Lake City, UT (US)

(72) Inventors: Edward WALKER, Salt Lake City, UT (US); Alexander Khan, Salt Lake City, UT (US); John Morrell, Orem, UT (US); Kye Elliott, Midvale, UT (US)

(21) Appl. No.: 18/406,512

(22) Filed: Jan. 8, 2024

(51) Int. Cl. B25J 9/16; B25J 15/06; B65B 25/06; B65B 35/16; B65B 57/12; G06T 7/70

(52) U.S. Cl. CPC B25J 9/1697; B25J 15/0625; B65B 25/065; B65B 35/16; B65B 57/12; G06T 7/70; G06T 2207/10028

(57) ABSTRACT

Picking and placing objects may be performed using a system based on 2-D or 3-D vision being used to control a robotic arm system having a gripper. Objects to be picked up and placed into one or more containers may be conveyed to a pick and place apparatus under control of a sensor camera whose output may be processed to provide control signals to the robotic arm system. Multiple such systems may be used to operate on one or more streams of objects being conveyed. The objects may be food items, such as, but not limited to, sliced meat or cheese, and the slices may be picked up and placed into containers for further processing, such as vacuum sealing.

### FIELD OF ENDEAVOR

Aspects of the present disclosure may relate to a robotic system for picking food portions and placing them into packaging.

### BACKGROUND

In food processing, portions of food may be generated and placed onto a conveying system, such as a conveyor belt or the like, and may then need to be picked up and placed into appropriate packaging. One particular case of this is the production of deli meat.

In producing “fluffed” deli meat (where slices are fluffed before being put in a container rather than stacked flat), portions of the meat may be picked up off of a conveyor system and carefully placed in a container. For purposes of safety and efficiency, these should be performed in a way that is A) food safe, B) reliably accurate and fast, and C) integrated within a meat processing line. It may also be desirable, as part of being fast, to be able to handle input from multiple conveyors.

Two primary solutions currently exist to perform this task but fail to simultaneously meet all of the above desired properties. The “traditional” method is to perform this task manually, in which humans pick up fluffed portions of meat and place them in containers, e.g., plastic containers, to be sealed. However, employers in the meat processing industry are faced with labor shortages, high rates of turnover, and absenteeism. These negatively affect reliability.

Large machine-based systems have also been developed to perform this task, such as that disclosed in U.S. Pat. No. 7,065,936, owned by Formax, Inc. However, this approach requires a large footprint in which the meat slicer, conveyor, and packaging system must be interconnected. In order to utilize this system, an existing meat processing facility would need to redo its meat processing line; that is, the machine proposed by Formax, Inc. cannot simply be integrated without a major plant overhaul, making it difficult and expensive to incorporate into an existing facility.

Other systems have been proposed, such as those in U.S. Patent Application Publication No. 2010/0101191, U.S. Pat. Nos. 9,956,691, 8,627,941, and U.S. Patent Application Publication No. 2008/0131253. However, each one of these proposed systems suffers from one or more drawbacks with respect to the desirable properties discussed above.

Another drawback to prior proposed automated pick and place systems relates to that they are not capable of discerning placement and orientation of the food/meat product on the input conveyor to the pick and place system. Rather, the food or meat product must be positioned and oriented precisely in order to allow the pick and place system to operate properly.

It would, therefore, be desirable to provide a pick and place method and system that is automated, food-safe, reliable, flexible, accurate, fast, and fully integrable within a food processing line without the need for a major overhaul of the food processing line.

### SUMMARY OF THE DISCLOSURE

The above goals may be achieved by means of a pick and place system according to aspects of the present disclosure. According to one aspect of the present disclosure, an autonomous robotic pick and place system may be provided. The system may utilize two-dimensional (2-D) and/or three-dimensional (3-D) computer vision to guide a robotic arm that may be equipped with a gripper, such as a vacuum gripper. The computer vision system may be used to locate a piece of food, e.g., but not limited to meat, on a conveyor belt that conveys the food. The output of the computer vision system may be used to guide the robotic arm to pick up a given portion of food (e.g., a slice of meat) and place it into packaging. The computer vision system(s) may be communicatively coupled to a computer, and the computer may provide commands to control the robotic arm. A graphical user interface (GUI) may allow a human operator to initiate and/or otherwise control operation of the system.

According to a further aspect of the present disclosure, a method of performing picking and placing using one or more robotic arms may be provided. The method may involve using 2-D and/or 3-D computer vision to identify pieces of meat approaching on a conveyor apparatus, such as a conveyor belt, and controlling one or more robotic arms to perform pick and place operations.

According to yet a further aspect of the present disclosure, a non-transitory computer-readable medium may contain executable code that results in implementation of the described method.

### BRIEF DESCRIPTION OF ACCOMPANYING DRAWINGS

Various aspects of this disclosure will now be discussed in further detail in conjunction with the attached drawings, in which:

FIG. 1 shows a conceptual block diagram of a meat/food processing system that may incorporate aspects of the present disclosure;

FIG. 2 shows a conceptual example of a pick and place system according to aspects of the present disclosure;

FIG. 3 shows a further conceptual example of a pick and place system according to aspects of the present disclosure;

FIG. 4 shows a conceptual example of a pick and place system according to aspects of the present disclosure;

FIGS. 5A and 5B show conceptual examples of component units that may be used to implement picking and placing according to aspects of the present disclosure;

FIG. 6 shows a conceptual block diagram of a sub-system according to further aspects of the present disclosure;

FIG. 7 shows a conceptual block diagram of a pick and place system according to further aspects of the present disclosure;

FIG. 8 shows an example of a conceptual user interface that may be used as part of a pick and place system according to aspects of the present disclosure; and

FIG. 9 shows a conceptual flowchart of an overview of a process according to aspects of the present disclosure; and

FIG. 10 shows a conceptual flowchart of a process according to aspects of the present disclosure.

### DETAILED DESCRIPTION OF ASPECTS OF THE DISCLOSURE

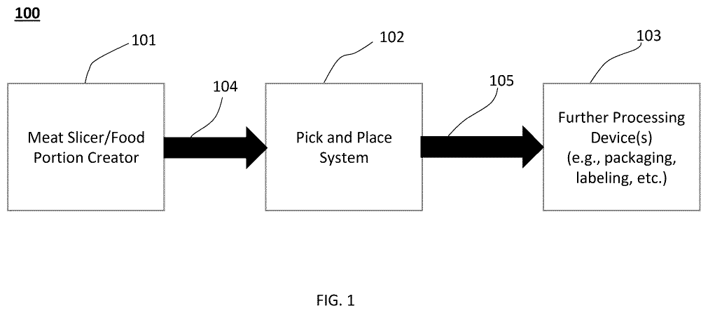

FIG. 1 shows a conceptual block diagram of a meat or other food processing system 100 that may incorporate a pick and place system according to aspects of the present disclosure. In the following discussion, meat (in slices (e.g., deli meat) or other types) will be discussed; however, it should be understood that the apparatus and processes discussed herein are more generally applicable to other types of food, as well (as an example, slices of meat could be, instead, slices of cheese, or a piece of meat could be a block of cheese). Slices of meat may be cut from larger pieces of meat using a slicer 101. The resulting slices may land or otherwise be transferred to a first conveyor 104, which may be, for example, a conveyor belt (but the invention is not thus limited). The first conveyor 104 may transport the meat slices to a pick and place system 102. The pick and place system may take up the slices of meat from first conveyor 104 and place them in containers (e.g., but not limited to plastic containers) located on second conveyor 105 (which may be, for example, a conveyor belt, but the invention is not thus limited). The containers containing the sliced meat may then be conveyed to further processing devices 103, which may perform such operations as packaging, sealing, and/or labeling, as non-limiting examples.

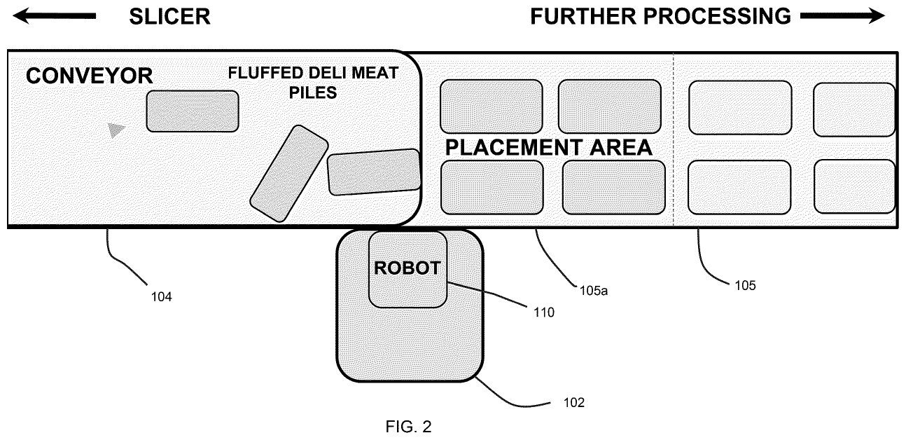

FIG. 2 presents a conceptual block diagram containing a further-detailed view of the conceptual block diagram of FIG. 1. As shown, e.g., fluffed deli meat slices, which may or may not be piles of slices, may be conveyed by first conveyor 104 to pick and place system 102. The orientation and spacing of the fluffed deli meat slices may not necessarily be regular, as shown (in fact, “fluffed” is a term-of-art that describes that slices do not lie flat on top of one another and instead are more randomly piled; this may typically occur as slices fall out of a slicer). The pick and place system 102 may include a robot 110 that may be used to pick up the slices/piles and place them into container in a placement area 105a of second conveyor 105.

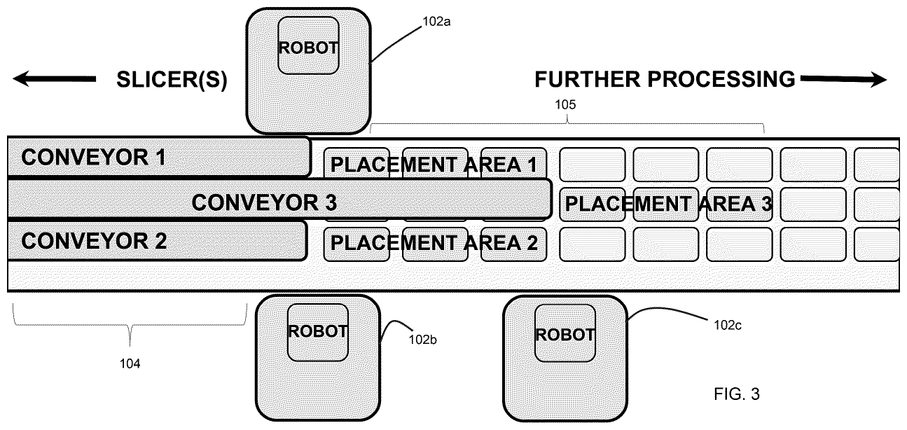

While FIG. 2 shows a single first conveyor 104 and single pick and place system 102, the invention is not thus limited. To the contrary, FIG. 3 shows a conceptual example of how there may be multiple first conveyors 104 (Conveyor 1, Conveyor 2, Conveyor 3) that may be serviced by pick and place systems 102a, 102b, and 102c, each of which may pick up the meat from a respect one of the first conveyors and place it into containers in a respective placement area of second conveyor 105. Note that while FIG. 3 shows all of the first conveyors 104 oriented parallel to one another, the invention is not thus limited, and first conveyors may be oriented in other directions.

It is further note in connection with FIGS. 2 and 3 that a number of containers to be filled by a given pick and place system is not limited to the numbers shown in these drawings.

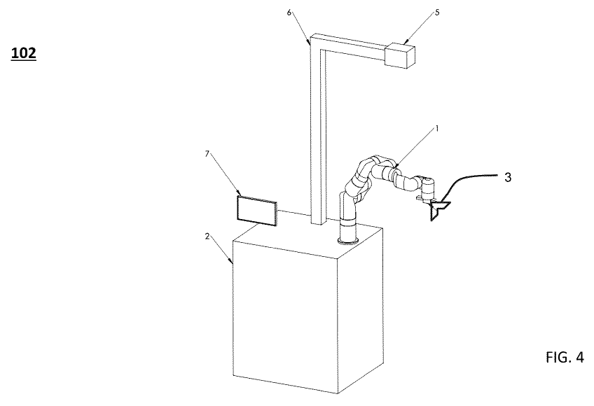

FIG. 4 shows a conceptual diagram of an example of a pick and place system 102 according to aspects of the present disclosure. A robotic arm 1 may be mounted on a pedestal cabinet 2. Pedestal cabinet 2 may be used to enclose a computer and may, for example, be constructed of stainless steel. A gripper 3 may be attached to robotic arm 1; this may be done in a detachable manner using a mount, e.g., a stainless steel mount, but the invention is not thus limited. Gripper 3 may be, for example, a soft gripper or a vacuum gripper, but the invention is not thus limited. Although not shown in order to more clearly show robotic arm 1, robotic arm 1 may be covered in a sleeve made of a food-safe fabric. A sensor camera 5 may be mounted on a mount 6, which may, for example, be crafted of stainless steel. Sensor camera 5 may be vertically offset from the top of cabinet 2, and the mount 6 may enable sensor camera 5 to have a field of view that includes slices/piles of slices of meat as they are conveyed by first conveyor 104 to pick and place system 102. A computer (not shown) within cabinet 2 may be communicatively coupled with sensor camera 5 and robotic arm 1 to obtain image information from sensor camera 5 and to process the image information to determine control signals to provide to robotic arm 1. The computer may be coupled to a user interface 7, which may be, e.g., but is not limited to, a touchscreen display.

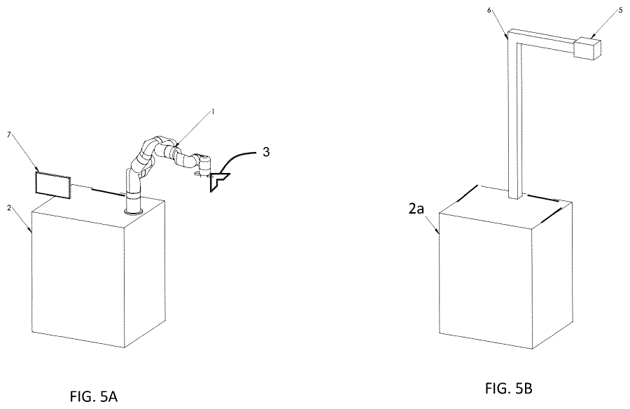

While FIG. 4 shows robotic arm 1 and sensor camera 5 mounted on a common cabinet 2, this is not the only possible implementation of pick and place system 102. As shown in FIGS. 5A and 5B, the sensor camera 5 and the robotic arm 1 may be mounted separately, e.g., on respective pedestal cabinets 2 and 2a. In such a case, wired or wireless communications may be used to couple sensor camera 5 and robotic arm 1 to obtain image information and to provide control signals. In the case of FIG. 3 in which there may be multiple pick and place systems, each pick and place system may include its own associated sensor camera 5, or only a fewer number of sensor cameras (e.g., but not limited to, one) may be used to obtain the visual information used in the pick and place systems 102x. Additionally, each sensor camera 5 need not necessarily be mounted above a conveyor; a side-mounted sensor camera 5, which may be on its own pedestal cabinet 2a or may be attached to a mount attached to first conveyor 104 and may be adapted to transmit its signals to a computing system, may also or alternatively be used. Furthermore, a sensor camera 5 located above first conveyor 104 may be similarly mounted on a mount attached to first conveyor 104. Finally, a sensor camera 5 need not be limited to a fully vertical or fully horizontal point-of-view with respect to first conveyor 104; other angles may be used. Any angle chosen for mounting a sensor camera 5 may be accommodated via appropriate signal processing software executed by an associated computing system, as is known in the art.

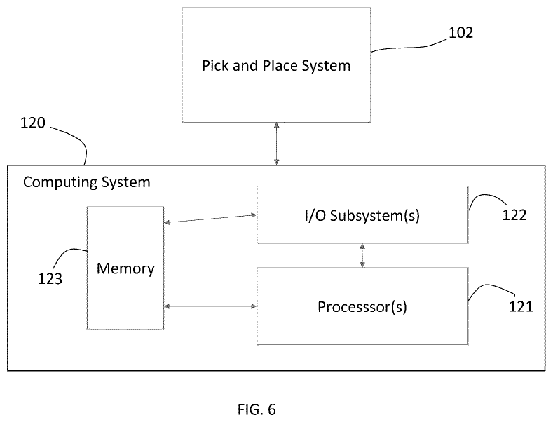

FIG. 6 shows a computing system 120 coupled to a pick and place system 102, according to an aspect of the present disclosure. As previously noted, the computing system may be disposed within cabinet 2; however, the invention is not thus limited, and the computing system 120 may be disposed externally to system 102. In the case of multiple pick and place systems 102x, e.g., as shown in FIG. 3, each may have its own associated computing system 120, or they may share a single computing system 120 and may be communicatively coupled to the computing system 120 via wired or wireless connection, including via a local area network (LAN). Computing system 120 may be located in a facility containing the meat processing system 100 of FIG. 1, or it may be one or more remote servers, connected via one or more communication networks, which may include the Internet. In the latter case, the computing system 120 may provide computing and control services for multiple meat processing systems 100, which may be located in multiple locations.

As shown in FIG. 6, computing system 120, whether located in a cabinet 2, locally in the meat-processing facility, or remotely located, may, for example, include one or more processors 121, which may be communicatively coupled to one or more memory devices 123, either or both of which may be communicatively coupled to one or more input/output (I/O) subsystems 122. User interface 7, as shown in FIGS. 4 and 5A, is an example of one I/O subsystem 122, but I/O subsystems 122 may include user interfaces other than a touchscreen display (e.g., mouse, keyboard, non-touchscreen display, speaker, microphone, etc.), one or more communication interfaces (e.g., transmitters, receivers, network cards, antennas, modems, etc.), and/or other such components. At least one non-transitory memory device of memory 123 may store executable instructions designed to be executed by the processor(s) 121 to cause the computing system 120 to implement various methods, such as image processing and robotic arm control, but which are not thus limited. Detailed examples of operations that may be implemented are discussed below.

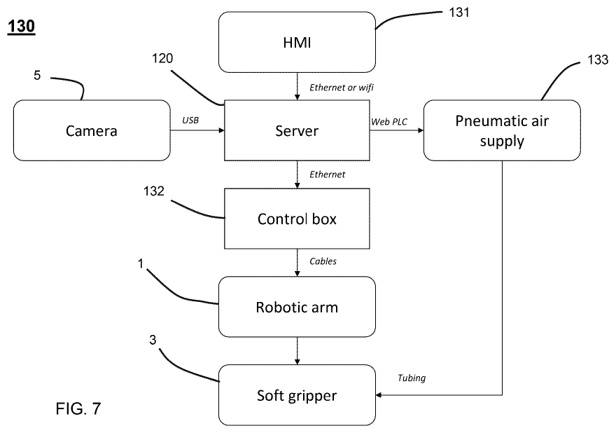

FIG. 7 shows a conceptual block diagram of a network configuration 130 according to an aspect of the present disclosure. Human-machine interface (HMI) 131 may be communicatively coupled to a computing system/server 120 and may comprise user interface 7. HMI 131 may be communicatively coupled to server 120 via an Ethernet® connection or WiFi® connection or via some other known connection. Sensor camera 5 may also be communicatively coupled to server 120, e.g., via a USB interface; however, the invention is not thus limited, and sensor camera 5 may be connected via a different type of interface. Robotic arm 1 and soft gripper 3 may be directly controlled by an accompanying control box 132, which may be coupled to robotic arm 1 via one or more cables. The control box 132 may be communicatively coupled to server 120, which may provide control signals to the control box 132, which may then translate the control signals into commands for various components of robotic arm 1 and soft gripper 3. Control box 132 may also provide feedback signal to server 120, e.g., to enable server 120 to fine-tune control of the robotic arm 1 and soft gripper 3 and/or in case of a malfunction. Server 120 may further be communicatively coupled to a pneumatic air supply 133 to control air supply to soft gripper 3 via tubing; note that the coupling between server 120 and pneumatic air supply 133 may be via a web programmable logic controller (PLC) interface, but is not thus limited. It is noted that if element 3 is comprised of a vacuum gripper rather than a soft gripper, pneumatic air supply 133 may be replaced by a vacuum generator.

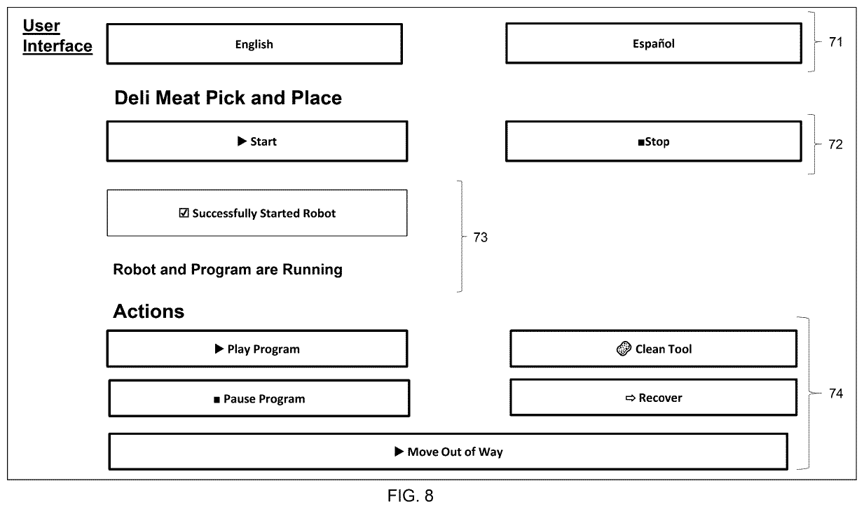

FIG. 8 shows a conceptual example of a user interface display 7, which may be a touchscreen display, but which is not thus limited. Display 7 may optionally offer the user a choice of two or more languages 71; however, the invention is not thus limited. Start/stop buttons, which may be touched or selected/clicked on by the user may be provided, and an accompanying display may show the system status 72. The user may also be provided with various choices of actions that may be taken 73.

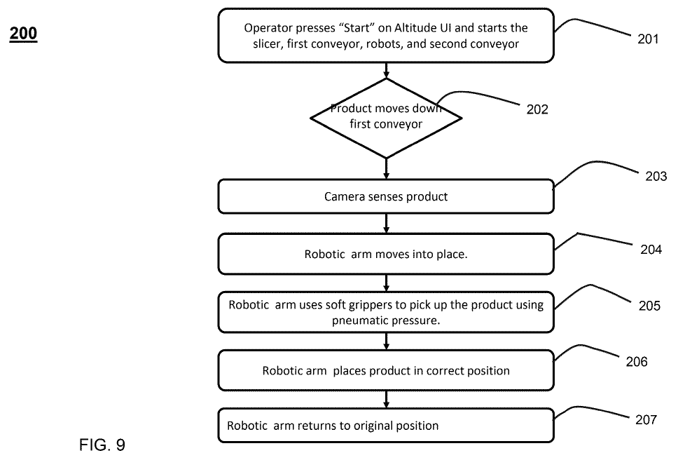

FIG. 9 shows a high-level flowchart 200 of operations according to aspects of the present disclosure. Operations may be initiated by a user causing the system to start 201, e.g., by pressing a “Start” button on user interface 7. Slices of meat (“product”) may then be produced by slicer 101 and conveyed 202 by first conveyor 104. Considering the case shown in FIG. 2 (single pick and place system), without loss of generality and without limitation, sensor camera 5 may sense product 203 on first conveyor 104. Computing system 120 may provide control signals to control box 132 to move robotic arm 1 into place for operating on the product 204. Computing system 120 may then provide further signals to control box 132 to cause robotic arm 1 and gripper 3 to pick up product 205 from first conveyor 104. The robotic arm 1 may then be controlled to place the product into an appropriate position 206 in a container on second conveyor 105. Following this, the robotic arm 1 may then be controlled to return to its original position 207.

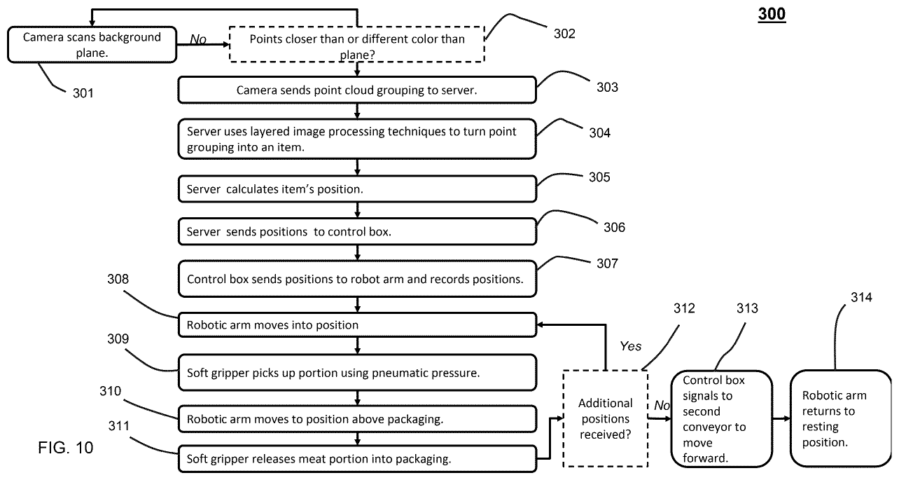

FIG. 10 shows an example 300 of how elements 203-207 of FIG. 9 may be implemented, according to aspects of the present disclosure. Sensor camera 5 may scan a background plane (e.g., first conveyor 104) 301 within a predetermined region, based on 3-D point cloud imaging. If sensor camera 5 detects that a point cloud image contains points above or having a color (including shades of gray in a non-color image) different from that of the background plane 302, the process continues to 303; otherwise, the process loops back to 301. In block 303, the sensor camera 5 may transmit a resulting point cloud grouping to computing system 120. The computing system 120 may then apply layered image processing techniques to the point cloud grouping 304 to create a 3-D item. Techniques used may include object segmentation, wherein the system may include a neural network trained on the color and depth data of the conveyor line as the product is conveyed. Other techniques, which may be used in combination with a neural network or instead, may include Gaussian derivative techniques (e.g., multi-scale Gaussian derivatives that may include a range of orders), local minimum and maximum intensity projections, and/or other known 2-D and/or 3-D image processing techniques. The computing system 120 may then, based on the resulting 3-D item, determine a position(s) of item(s) on first conveyor 104, in block 305, which may indicate positions to which robotic arm 1 and gripper 3 may be moved to pick up the item(s). The position(s) of the item(s) may be transmitted 306 to the control box 132 of robotic arm 1. Control box 132 may then send the appropriate instructions 307, based on the position(s), to robotic arm 1, which may then move 308 to the indicated position(s) such that gripper 3 and robotic arm 1 may pick up each item. The gripper 3 may be controlled 309 to pick up an item, e.g., using air pressure supplied by pneumatic air supply 133. In block 310, the robotic arm 1 may then be moved to a position above packaging, and gripper 3 may be controlled 311 to release the item into the packaging. In this process, the robotic arm may be moved so as to rotate the item in a horizontal plane so that the item will properly fit into the packaging. This process may be repeated if it is determined 312 that further positions (of items) have been received by the control box 132. If not, the control box may control second conveyor 105 to move forward 313. Note that second conveyor may be integrated into further processing apparatus or may carry the item(s) in the package(s) along for further processing in other apparatus. The robotic arm 1 may also be moved to its original “resting” position 314.

It is noted that, in addition to controlling the picking up of items and placing them into packaging, the computing system 120 may be further programmed to control slicer 101 and downstream processing apparatus 103. For example, a given pick and place system (or multiple such systems) may have (respective) containers to fill, and the computing system 120 may keep track of the containers that have been filled. Once the pick and place system(s) has/have filled all of its/their (respective) containers, computing system 120 may signal to the downstream processing apparatus 103 and/or to second conveyor 105 to move forward to expose further containers to be filled, and may also provide a “ready” signal or other control signals to downstream processing apparatus 105, which may include a vacuum sealing system, such as one manufactured by Multivac®.

If the pick and place system 102 is stopped for some reason, computing system 120 may further generate control signals to slicer 101, conveyors 104, 105, and downstream processing apparatus 103 to indicate this. In one example, computing system 120 may control the entire process so that, in the case of stoppage of pick and place system 102, the other components are also stopped.

In a further example, in which multiple pick and place systems 102x (see the example of FIG. 3) are used to service multiple conveyors 104, all of the systems 102x may make use of a single, centrally placed sensor camera 5 (which may be mounted on one of them as in FIG. 4 or may be separately mounted as in FIG. 5B), or each one may have its own sensor camera 5. In an example in which each pick and place system 102x is equipped with its own individual computing system 120, one of the pick and place systems 102x may serve as a “lead” pick and place system to keep track of overall filling of the containers by all of the pick and place systems 102x, and its associated computing system 120 may provide control signals as described above to move the containers forward. The computing system 120 of the lead pick and place system 102x may also be used to control the other pick and place systems 102x, and they may all be operated in tandem.

It is further noted that the disclosed pick and place system 102, while disclosed in the context of food packing and processing, is not thus limited and may be used similarly in a context involving non-food items. In such use, gripper 3 may take various forms as may be appropriate to the type of product being picked up and placed.

Various aspects of the disclosure have been presented above. However, the invention is not intended to be limited to the specific aspects presented above, which have been presented for purposes of illustration. Rather, the invention extends to functional equivalents as would be within the scope of the appended claims. Those skilled in the art, having the benefit of the teachings of this specification, may make numerous modifications, including using features described above in combination with each other but not specifically disclosed in combinations described above, without departing from the scope and spirit of the invention in its various aspects.

What is claimed is:

1. A pick and place apparatus including:
a sensor camera disposed to obtain one or more images of one or more items as the one or more items are conveyed to the pick and place apparatus;
a computing device communicatively coupled to the sensor camera to receive and process the one or more images;
a robotic arm system communicatively coupled to the computing device to receive control instructions from the computing device; and
a gripper coupled to the robotic arm system,
wherein the robotic arm system and the gripper are controlled by the computing device to pick up the one or more items and to place them into one or more containers.

2. The pick and place apparatus according to claim 1, wherein the robotic arm system includes a control box coupled to receive the control instructions; and a robotic arm coupled to the control box to receive control signals from the control box.

3. The pick and place apparatus according to claim 1, wherein the sensor camera and the robotic arm system are mounted on separate bases.

4. The pick and place apparatus according to claim 1, further including a user interface coupled to the computing device to enable a user to control operation of the pick and place apparatus.

5. The pick and place apparatus according to claim 1, wherein the gripper comprises a soft gripper, and wherein the pick and place system further includes a pneumatic air supply coupled to the soft gripper, wherein the pneumatic air supply is configured to supply air to the soft gripper under control of the computing device.

6. The pick and place apparatus according to claim 1, wherein the one or more containers are located on an apparatus arranged to convey the one or more containers to additional apparatus for further processing.

7. The pick and place apparatus according to claim 1, wherein the one or more items are one or more food items.

8. The pick and place apparatus according claim 7, wherein the one or more food items are sliced meat.

9. A pick and place system comprising at least two of the pick and place apparatuses according to claim 1.

10. The pick and place system according to claim 9, wherein the computing device of one of the at least two pick and place apparatuses is programmed and communicatively coupled to control operation of all of the at least to pick and place apparatuses.

11. A method of operating a pick and place apparatus, the method including:
detecting one or more items approaching the pick and place apparatus based on obtaining one or more images of the one or more items as they are conveyed to the pick and place apparatus;
processing the one or more images to determine positions and orientations of the one or more items; and
conveying instructions to at least one robotic arm system having a gripper mounted thereon to instruct the at least one robotic arm system to pick up the one or more items and to place the one or more items into one or more containers.

12. The method according to claim 11, wherein the one or more images comprise one or more point cloud images.

13. The method according to claim 12, wherein the processing the one or more point cloud images includes applying one or more layers of image processing techniques to convert the one or more point cloud images into one or more imaged items, wherein the positions and orientations of the one or more items are determined from the one or more imaged items.

14. The method according to claim 11, wherein the detecting the one or more items includes:
scanning a predetermined scanning region; and
detecting one or more points that are greater in height than other points in the scanning region.

15. The method according to claim 11, wherein the detecting one or more items includes:
scanning a predetermined scanning region; and
detecting one or more points that are different in color from a background plane.

16. The method according to claim 11, further including:
controlling a pneumatic air supply coupled to the gripper to enable the gripper to grip an item of the one or more items.

17. The method according to claim 11, wherein the instructions further instruct the robotic arm system to retract to a resting position after performing one or more pick and place operations.

18. The method according to claim 11, further including:
monitoring filling of the one or more containers to determine if the one or more containers are full; and
if the one or more containers are full, providing at least one control signal to move the one or more full containers and to move one or more empty containers into position to be filled.

19. A non-transitory computer-readable medium having executable code stored thereon designed to cause one or more processors to implement operations to perform the method according to claim 11.
